(19) United States
(12) Patent Application Publication
(10) Pub. No.: US 2018/0050323 A1
(43) Pub. Date: Feb. 22, 2018

(54) WATER PURIFICATION CATALYST, WATER PURIFIER, BEVERAGE MAKER AND METHOD

(71) Applicants: KONINKLIJKE PHILIPS N.V., EINDHOVEN (NL); UNIVERSITEIT TWENTE, ENSCHEDE (NL)

(72) Inventors: WILHELMUS HENDRIKUS MARIA BRUGGINK, EINDHOVEN (NL); PAULUS CORNELIS DUINEVELD, EINDHOVEN (NL); ROGER BRUNET ESPINOSA, EINDHOVEN (NL); DAMON RAFIEIAN, EINDHOVEN (NL); ROB LAMMERTINK, EINDHOVEN (NL); LEON LEFFERTS, EINDHOVEN (NL)

(21) Appl. No.: 15/557,309

(22) PCT Filed: Mar. 25, 2016
(86) PCT No.: PCT/EP2016/056735

§ 371 Date: Sep. 11, 2017

(30) Foreign Application Priority Data
Mar. 27, 2015 (EP) 15161426.0

(51) Int. Cl. B01J 23/44; C02F 1/32; C02F 1/70; B01J 23/89

(52) U.S. Cl. CPC B01J 23/44; C02F 1/325; C02F 2101/163; B01J 23/8926; C02F 1/70

(57) ABSTRACT

There is provided a water purification catalyst element (100). The catalyst element (100) comprises a porous support (102) having a first surface (106) and a second surface (110). The first or the second surface (106, 110) delimit a conduit (114) through the catalyst element (100). A material (104) comprising a noble metal is supported on the porous support (102). At least the first surface (106) is coated with a coating material (108) permeable to hydrogen gas and impermeable to water, and at least the second surface (110) is water-permeable. This catalyst element (100) can selectively convert nitrites and/or nitrates to N₂ gas and can be used to provide a cost efficient and/or maintenance free water purification setup. There is also provided a water purifier (200) comprising the catalyst element (100), a beverage maker (300) comprising the water purifier (200), a method (1800) of water purification and a method (1900) of making the catalyst element (100).

### FIELD OF THE INVENTION

The present invention relates to a water purification catalyst element, in particular to a water purification catalyst for decomposition of nitrites. The present invention also relates to a water purifier comprising the catalyst element, and a beverage maker comprising the water purifier. The present invention also relates to a method of water purification and a method of making the water purification catalyst element.

### BACKGROUND OF THE INVENTION

Nitrites (NO₂⁻) and/or nitrates (NO₃⁻) may be present in water from a number of sources. It is known that exposure to significant amounts of nitrates and nitrites can present a significant health risk and the World Health Organization has published guideline levels of nitrate and nitrite levels in water fit for human consumption. Nitrite ions are considered to be the more harmful species and, consequently, the maximum recommended concentration levels are lower (<1-3 mg/l) than for nitrate (<50 mg/l). Conventional nitrite and nitrate removal technologies focus on selective absorption or retention or biological/chemical denitrification of nitrogen containing compounds. However, these technologies require strict maintenance of specific process conditions to ensure adequate removal of nitrites and nitrates.

It is also known that there is increased pressure on natural water reserves as a result of a number of factors including increased urbanization, intensified agricultural activities and increased presence of (organic) micro-pollutants, as a result higher pollution loads have to be handled. This creates challenges even for more advanced water treatment technologies. As public water suppliers have more and more difficulties in meeting on the one hand increased demand (quantity) and on the other hand acceptable quality criteria many consumers reach out for so-called Point-of-Entry (POE) and Point-of-Use (POU) devices. These devices aid in the preparation of high quality drinking water meeting the standards set for human consumption.

In recent years so-called advanced oxidation treatment technologies have gained more traction due to their powerful combination of disinfection capabilities and non-selective (organic) micropollutant degradation. Advanced Oxidation treatment technologies are applied to degrade non-selectively many micro-pollutants and/or to inactivate micro-organisms. The treatment technology is based on use of low wavelength light (UV-range of 100-400 nm) stand alone or in combination with (on-site) generated ozone or hydrogen peroxide. Many water utilities around the world have switched from conventional water treatment technology, such as coarse sediment filtration flocculation, aeration and chlorination, to advanced oxidation technologies such as UV-C, UV/O₃ and UV/H₂O₂. Due to the generation of on-site radicals many (organic) pollutants are degraded into basic minerals. However, due to the nature of such advanced oxidation processes nitrogen containing substances, including nitrates, may get converted into more harmful nitrogen containing compounds such as nitrites. This is especially the case when a low wavelength lamp (higher photon energy levels) with λ<230 nm is used, as these wavelengths are absorbed significantly by nitrate ions, especially when compared with standard 254 nm LP mercury lamp wavelengths, and photolysis of nitrates is known to be a source of more harmful nitrites. As the harmful concentration of nitrite is substantially lower than that of nitrate it is possible that maximum nitrite levels are exceeded. In a post processing step these nitrites therefore need to be removed.

Conventional nitrite/nitrate removal technologies are based on Ion Exchange Technologies (IEX), Reverse Osmosis (RO), Electrodialysis (ED), biological denitrification and/or chemical denitrification. In case of IEX the nitrogen containing ionic species are absorbed into a functionalized polymeric matrix. Since such a polymeric matrix has finite absorption capacity, it requires adequate process control to monitor for the situation in which the matrix is ‘full’ and is no longer effective. This makes such systems expensive and difficult to implement, particularly on a small scale, such as residential systems or consumer operated devices. A similar situation occurs in other known technologies such as those listed above, therefore they also require advanced control mechanisms, are inherently expensive and are therefore unsuitable for small scale systems, such as residential systems or consumer operated devices.

M. Reif and R. Dittmeyer, Catalysis Today 82 (2003) 3-14 describe porous catalytically active ceramic membranes for gas-liquid reactions. In this paper, a comparison is presented between catalytic diffuser and forced through flow concepts and discusses their application for hydrogenation processes, like the catalytic nitrate/nitrite reduction in water. This paper describes that the reactant diffuses through the porous structure of the membrane to the catalytic sites. The gaseous reactant is fed through the support to the catalytic layer from the other side of the membrane. Two reactants approach the catalytic layer from opposite sides. The gas-liquid phase boundary is determined by the pressure difference between the gas and the liquid side.

### SUMMARY OF THE INVENTION

The present invention inter alia seeks to provide a water purification catalyst element for the decomposition of nitrites, a water purifier comprising such a catalyst, a beverage maker comprising such a water purifier, a method of water purification, and a method of making a water purification catalyst element. The invention is defined by the independent claims. Advantageous embodiments are defined in the dependent claims. According to an aspect, there is provided a water purification catalyst element (herein also indicated as “catalyst element”) comprising a porous support having a first surface and a second surface, and a material comprising a noble metal supported on the porous support; wherein at least the first surface is coated with a coating material permeable to hydrogen gas and impermeable to water, and at least the second surface is water-permeable.

This catalyst element can selectively convert nitrites to N₂ gas and can be used to provide a cost efficient and/or maintenance free water purification setup. Further, this catalyst element can provide limited formation of unwanted by products such as NH₄⁺ ions and more complete reduction of nitrites to nitrogen gas and water, which typically form when the nitrogen-containing water meets the hydrogen gas. Without wishing to be bound by theory, due to the fact that the water to be treated is provided to the catalyst via a separate surface from the surface through which the hydrogen gas is provided, the ratio of local hydrogen-nitrite concentrations at the catalyst element is more controlled. This is so because the coating material creates a hydrogen resistance and therefore lowers the hydrogen local concentration at the catalyst element, thus reducing the formation of said unwanted by-products. Such a catalyst element has particular utility in a small scale, e.g. consumer, implementations.

The porous support may be or comprise at least one selected from the group consisting of a hydrophilic material, an inorganic material such as α-alumina or γ-alumina and combinations thereof.

The porous support may further comprise a surface area increasing additive selected from the group consisting of carbon nanofibers (CNF); carbon nanotubes (CNT); spherical carbon particles, such as activated carbon; and combinations thereof, wherein the material comprising a noble metal is supported on the porous support by the surface area increasing additive.

Such materials may have a large surface area for supporting the material comprising the noble metal, which can in turn provide increased active catalyst surface area and in turn greater catalytic activity.

The noble metal may be selected from the group consisting of palladium (Pd), Platinum (Pt), Rhodium (Rh), Ruthenium (Ru), Iridium (Ir) and combinations thereof.

The material comprising a noble metal may further comprise at least one additional non-noble metal selected from the group consisting of copper (Cu), tin (Sn), Cobalt (Co), Nickel (Ni), and combinations thereof. Such materials may enhance the catalytic activity of the catalyst element. In particular, such a catalyst element may have particular activity towards nitrates as well as nitrites. In a similar way to as described above, this catalyst element can also convert nitrates to N₂ gas and can provide limited formation of unwanted by products such as NH₄⁺ ions and more complete reduction. Without wishing to be bound by theory, due to the fact that the water to be treated is provided to the catalyst via a separate surface from the surface through which the hydrogen gas is provided, the ratio of local hydrogen-nitrate concentrations at the catalyst element is more controlled. This is so because the coating material creates a hydrogen resistance and therefore lowers the hydrogen local concentration at the catalyst element, thus reducing the formation of said unwanted by-products.

The coating material may be or comprise a polymer such as a polysiloxane polymer. Polysiloxane polymers, such as PDMS, present a readily available coating material suitable for use as the coating material.

The first or the second surface may delimit a conduit through the catalyst element. Such a conduit can then be used to feed hydrogen gas or water to the first or second surface of the porous support, respectively.

According to another aspect, there is provided a water purifier comprising at least one catalyst element as described above; a water inlet for water to be treated, wherein the water inlet is configured to supply water to the second surface of the at least one catalyst element; a water outlet for treated water, wherein the water outlet is configured to draw water from the second surface of the at least one catalyst element; and a gas inlet for hydrogen gas, wherein the gas inlet is configured to supply hydrogen gas to the first surface of the at least one catalyst element; wherein the water inlet and the water outlet define a water flow path over the second surface of the at least one catalyst element.

Such a water purifier may provide the advantages of the catalyst element discussed above.

The water purifier may further comprise a light source which emits light in the wavelength range of from 100 nm to 400 nm, especially 100 to 260 nm, e.g. in the range of from 150 to 230 nm, wherein the light source is arranged to illuminate the water along at least a portion of the flow path. Accordingly, the water purifier may be used additionally to break down (organic) chemicals which may be present in the water to be treated or to kill bacteria or other organisms which may be present.

The catalyst element may be arranged upstream of the light source in the flow path. Such an arrangement may be particularly effective where it is desired to remove nitrites and/or nitrates from water to be treated before treating the water with a light source, particularly as nitrates and nitrites may absorb light from the light source such that it is not available to break down chemicals or to kill organisms.

The water purifier may further comprise an agitator for agitating the water in the flow path. An agitator may be used to increase the effectiveness or efficiency of the catalyst element within the water purifier, or to reduce the size or number of catalyst elements which are required.

The agitator may be configured to introduce a gas into the water in the flow path. Such an agitator may provide the additional benefit of increasing the radical formation rate and consequently the break-down of undesired chemicals present in the water to be treated.

The water purifier may further comprise a generator for generating hydrogen gas by electrolysis of water and for supplying the gas inlet with hydrogen gas. If a generator is included in the water purifier, an external source of hydrogen gas may not be required, such an arrangement may be particularly suitable for consumer water purifiers.

The water purifier may further comprise a water flow generator. This water flow generator, such as a pump, is especially configured to provide water to be purified to the water inlet (configured to supply water to the second surface of the at least one catalyst element). The water flow generator may be configured upstream from the water purifier or may be configured downstream from the water purifier. The term “water flow generator” may also refer to a plurality of water flow generators. Hence, the flow generator and the water inlet may together be configured to supply water to the second surface of the at least one catalyst element (upstream from the flow path). Further, the flow generator and the water outlet may together be configured to draw water from the second surface of the at least one catalyst element (downstream from the flow path).

Alternatively or additionally, the water purifier may be configured to use gravity for generation of a flow. For instance, the water purifier may include a water reservoir configured (during use of the water purifier) at a higher position than (at least part of) the catalyst element. The water reservoir is especially configured to store (temporarily) water to be treated.

Hence, in embodiments the water purifier is configured to provide a flow of water with a flow generator and/or due to gravity.

The term “water inlet” may also refer to a plurality of water inlets. The term “water outlet” may also refer to a plurality of water outlets. The term “gas inlet” may also refer to a plurality of gas inlets.

According to another aspect, there is provided a beverage maker comprising a water purifier as described above, wherein the water purifier is arranged to provide purified water to a beverage making stage of the beverage maker. Integration of the water purifier into a beverage maker can reduce the number of steps a consumer has to perform in preparing a beverage with purified water and thus increase convenience for the consumer, as the consumer does not need to separately purify the water. Such a beverage maker for instance may be a coffee and/or tea maker, where the water purifier is arranged to feed purified water into a brewing stage of the coffee maker.

The beverage maker, or water purifier per se, may optionally include a water reservoir, from which water can be provided to the water purifier. Such water reservoir is especially configured upstream from the catalyst element. Alternatively or additionally, the water purifier, or beverage maker comprising a water purifier, may be configured to be functionally connected to a water infrastructure (i.e. functionally connected to water mains). Hence, the water inlet may functionally be coupled with one or more of a water reservoir and a water infrastructure.

Herein, the term “configured to” may also be interpreted as “adapted to”. For instance, the agitator may be adapted to introduce gas into the water in the flow path.

The water purifier may also include a water storage configured to store water that has been purified by the catalyst element. Such storage is especially configured downstream from the catalyst element. Hence, the water outlet may functionally be coupled with a water storage. The generator for generating hydrogen gas by electrolysis of water and for supplying the gas inlet with hydrogen gas may especially be used in combination with the beverage maker.

According to another aspect, there is provided a method of water purification comprising supplying hydrogen gas to a first surface of a water-permeable porous support having a material comprising a noble metal supported thereon, wherein the first surface is coated with a coating material permeable to the hydrogen gas and impermeable to water; and supplying water to be treated to a water-permeable second surface of the porous support said first surface. The method may especially be applied with the water purification catalyst element as described herein and the water purifier as described herein. Hence, in yet a further aspect the invention also provides a method of water purification comprising supplying hydrogen gas and water to be treated to a water purifier as described herein, wherein hydrogen gas is supplied to the first surface of the water-permeable porous support, and wherein the water to be treated is supplied to the water-permeable second surface of the porous support said first surface.

This method can provide water with acceptable levels of nitrite contaminants and may simultaneously provide a particularly low level of by-products in the treated water. During use, the pressure of the water may e.g. be in the range of about 0.01-5 bar, such as 0.1-5 bar, like 0.5-2 bar. Hence, the water purifier may be configured to maintain a pressure of the water (at the second surface) in the range of about 0.01-5 bar. Therefore, in embodiment the pressure of the water in the flow path may be in the range of about 0.01-5 bar.

During use, the pressure of the hydrogen gas may be in the range of 0.0001-5 bar, such a 0.001-5 bar, like 0.01-2 bar. 0.0001 bar equals to 10 Pa. Hence, the water purifier may be configured to maintain a pressure of the hydrogen gas (at the first surface) in the range of about 0.0001-5 bar, such a 0.001-5 bar, like 0.01-2 bar.

According to another aspect, there is provided a method of making a catalyst element comprising providing a water-permeable porous support having a material comprising a noble metal supported thereon and having a first surface and a second surface; and forming a coating of a coating material on at least the first surface, wherein the coating material is permeable to hydrogen gas and impermeable to water, and leaving at least the second surface water-permeable.

This method provides the advantages of the catalyst element described above. These and other aspects of the invention will be apparent from and elucidated with reference to the embodiments described hereinafter.

### BRIEF DESCRIPTION OF THE DRAWINGS

Embodiments of the invention are described in more detail and by way of non-limiting examples with reference to the accompanying drawings, wherein:

FIG. 1 is a schematic perspective view of an embodiment of a catalyst element;

FIG. 2 is a schematic cross-sectional view of the catalyst element of FIG. 1;

FIG. 3 is a schematic expanded view of a part of the porous support of the catalyst element of FIG. 1;

FIG. 4 is a schematic cross-sectional view of an embodiment of a water purifier comprising a catalyst element;

FIG. 5 is an alternative schematic cross-sectional view of the water purifier of FIG. 4;

FIG. 6 is a schematic view of an alternative embodiment of a water purifier;

FIG. 7 is a schematic view of another alternative embodiment of a water purifier;

FIG. 8 is a schematic view of another alternative embodiment of a water purifier;

FIG. 9 is a schematic cross-sectional view of another alternative embodiment of a water purifier;

FIG. 10 is a graphical representation of the absorbance of nitrite and nitrate ions;

FIG. 11 is a graphical representation of the spectrum of a UV light source;

FIG. 12 is a schematic cross-sectional view of another alternative embodiment of a water purifier;

FIG. 13 is a graphical representation of the decomposition of KHP with gaseous air agitation and gaseous argon agitation;

FIG. 14 is a schematic cross-sectional view of another alternative embodiment of a water purifier;

FIG. 15 is a schematic cross-sectional view of another alternative embodiment of a water purifier;

FIG. 16 is a schematic cross-sectional view of another alternative embodiment of a water purifier;

FIG. 17 is a schematic cross-sectional view of another alternative embodiment of a water purifier;

FIG. 18 is a schematic cross-sectional view of another alternative embodiment of a water purifier;

FIG. 19 is a schematic cross-sectional view of another alternative embodiment of a water purifier;

FIG. 20 is a schematic cross-sectional view of another alternative embodiment of a water purifier;

FIG. 21 is a schematic cross-sectional view of an embodiment of a beverage maker;

FIG. 22 is a flow chart representing an embodiment of a method of purifying water; and

FIG. 23 is a flow chart representing an embodiment of a method of making a catalyst element.

### DETAILED DESCRIPTION OF EMBODIMENTS

It should be understood that the Figures are merely schematic and are not drawn to scale. It should also be understood that the same reference numerals are used throughout the Figures to indicate the same or similar parts.

In the present application, where multiple numerical ranges are contemplated for a particular feature, a lower end point of an embodiment of the numerical range may be used as a higher end point of another embodiment of the numerical range, and a higher end point of an embodiment of the numerical range may be used as a lower end point of another embodiment of the numerical range.

Embodiments of the present invention are concerned with water purification catalyst elements. An area of water purification identified for improvement is the provision of apparatus and methods for the removal of nitrites from water.

It is known to decompose nitrites and nitrates using a palladium catalyst and hydrogen according to the following reaction scheme:

2NO₃⁻+2H₂→2NO₂⁻+2H₂O

2NO₂⁻+3H₂+2H⁺→N₂+4H₂O

NO₂³¹ +3H₂+2H⁺→NH₄⁺+2H₂O

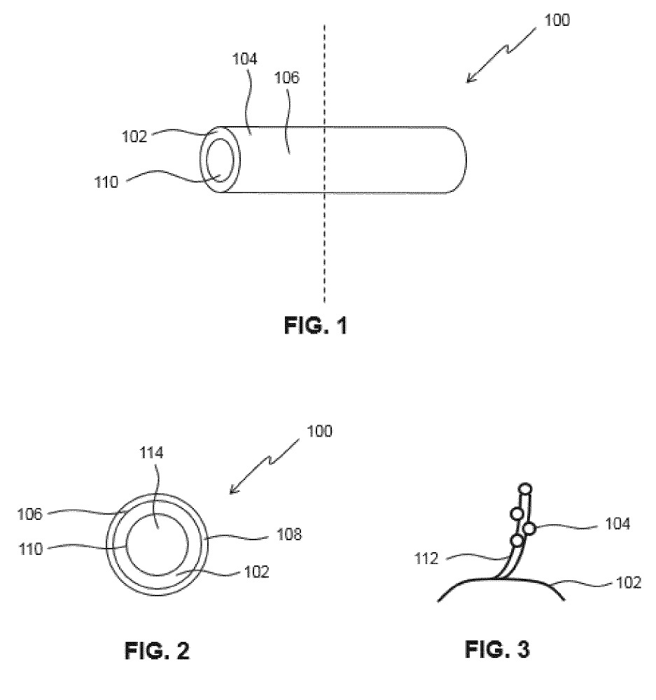

As realized by the inventors, the less harmful nitrate is first decomposed to the more harmful nitrite. Additionally, incomplete reduction can result in the formation of ammonia as an undesired by-product. It is therefore desired to provide a catalyst which can provide more complete reduction of nitrites (and optionally nitrates) to nitrogen and water. Referring firstly to FIGS. 1, 2 and 3 of the accompanying drawings, an embodiment of a catalyst element 100 can be seen to comprise a porous support 102. Supported on the porous support 102 is a material 104 comprising a noble metal. In an embodiment, the material 104 consists of noble metal particles. The size (diameter) of the noble metal particles may be less than 1 μm, e.g. less than 20 nm. A first surface 106 of the porous support 102 is coated with a coating material 108 permeable to hydrogen gas and impermeable to water. A second surface 110 is water-permeable, for reasons that will be explained in more detail below.

The catalyst element 100 can selectively convert present and/or generated nitrites (and in some embodiments, nitrates) to N₂ (gas). Such a catalyst element 100 can be used to provide a very cost efficient and/or maintenance free water purification setup.

This catalyst element 100 can provide limited formation of unwanted by-products such as ammonium ions (NH₄⁺) and more complete reduction of nitrites or nitrates and nitrites to nitrogen gas and water. The nitrogen gas is considered harmless and merely escapes from the water. Without wishing to be bound by theory, it is believed that the formation of ammonium ions and other by-products is limited as the hydrogen gas and the water carrying the nitrites or nitrates and nitrites are fed into the catalyst element 100 through separate surfaces, i.e. the first and second surfaces 106,110 respectively, such that the water to be treated and the hydrogen gas meet at the material 104 comprising the noble metal, e.g. at the noble metal particles. Accordingly, the ratio of local hydrogen-nitrite and/or hydrogen-nitrate concentration at the catalyst element 100 is more controlled. This is so because the coating material 108 creates a hydrogen resistance and therefore lowers the hydrogen local concentration at the catalyst element 100. This avoids or reduces the production of unwanted by-products, such as ammonium ions.

The catalyst element 100 may be used to advantage in combination with an advanced oxidation reactor setup. Such advanced oxidation reactor setups are known to the skilled person and include technologies such as UV-C, UV/O₃ and UV/H₂O₂. In particular, such technologies may generate nitrates and/or nitrites which may be converted to nitrogen gas using the catalyst element 100.

Further, this catalyst element 100 may be provided in a maintenance free form, avoiding a disadvantage of some conventional nitrite and nitrate removal technologies, which require costly maintenance in use. As discussed above, such maintenance makes the prior art technologies cumbersome for use in small scale, e.g. consumer, environments, as the end user must regularly check if the purifier needs replacing. Accordingly, the catalyst element 100 may advantageously be utilised in a small scale, e.g. consumer, situation as it does not require such periodic inspection.

Water treated with such a catalyst element 100 may be suitable for human consumption, in other words, the treated water may be purified drinking water. In this specification where it is stated that the coating material 108 is permeable to hydrogen gas this means that hydrogen gas can penetrate the coating material 108 and where it is stated that the coating material 108 is impermeable to water this means that water cannot penetrate the coating material 108. Such behaviour may be achieved in any known manner, e.g. by using a hydrophobic coating material and/or using a material having a small enough pore size to stop water from penetrating the material, and so on. Such materials are well-known per se and it is stipulated that any suitable hydrogen-permeable and water-impermeable material may be used for this purpose.

The porous support 102 can be made out of any suitable porous material known to the skilled person, for example any organic or inorganic material, a hydrophilic material may be particularly suitable in order the promote the penetration of the material with the water to be treated. In some embodiments the porous support 102 is made of an inorganic porous material such as α-alumina or γ-alumina, which inorganic porous material optionally may further comprise a surface area-increasing additive 112. α-Alumina may be preferred over γ-alumina as α-alumina has a higher porosity and allows the growth of a surface area-increasing additive 112 (such as CNF) inside the pores, as explained in more detail below. Additionally, the relatively large α-alumina pores may prevent diffusion limitations from playing a negative roll in the activity of the catalyst element. γ-alumina has very small pores (<10 nm) and therefore a high surface area, accordingly, a surface area increasing additive may not be required.

The porous construction generates a large surface in order to support the noble metal-containing material 104. The porous material may have a small pore size, for example less than 100 μm or less than 1 μm. A small pore size can provide a larger surface area, which in turn can provide an increased active catalyst surface area, which equates to greater catalytic activity of the catalytic element 100. The surface area of the porous material may be further increased by use of a surface area increasing additive 112, such as carbon nanofibers (CNF), as discussed in more detail below.

The thickness of the porous support 102 may be in the range of from 100 μm to 100 mm, e.g. in the range of from 250 μm to 2.5 mm.

Where the porous support 102 comprises a surface area-increasing additive 112, the additive 112 may, in some embodiments, be selected from the group consisting of carbon nanofibers (CNF), carbon nanotubes (CNT) and spherical carbon particles, such as activated carbon and combinations thereof. Where such an additive 112 is used, as shown in the close up view of FIG. 3, the material 104 comprising a noble metal may be supported on the porous support 102 by the surface area-increasing additive 112.

CNF or CNT may be grown in situ on the porous support 102 using a carbon growth catalyst, in which case the carbon growth catalyst may form a part of the catalyst element 100. For example, the inside of the porous support 102 may be coated with such a carbon growth catalyst. The carbon growth catalyst may be any standard carbon growth catalyst e.g. Ni or Co. However, iron is not favoured as the presence of an iron carbon growth catalyst has been found to negatively influence the performance of the catalyst element 100.

The carbon growth catalyst may be present as a layer on the porous support 102, the layer may be very thin, e.g. less than 100 μm thick or less than 1 μm thick. Alternatively, the carbon growth catalyst may be present in a particulate form, e.g. as nickel particles. Such carbon growth catalysts may be applied by standard processes such as homogeneous deposition precipitation methods or plasma methods. CNF or CNT may then be grown by standard process known to a person skilled in the art, such as the use of ethylene gas as a carbon source.

The CNF may have standard dimensions, i.e. dimensions that have been well-documented in the manufacture of such CNFs. For example the CNF may be less than 100 μm long or less than 1 μm in length. The thickness of the CNF may be between 1 and 1000 nm or between 5 and 20 nm. The surface area of the CNF may be high as is typical in standard CNF, for example in the range of from 50 to 1000 m²/g CNF or in the range of from 150 to 400 m²/g CNF. Where CNFs are used, the loading of the catalyst may be in the range of from 0.001 to 0.1 g/g CNF or from 0.005 to 0.05 g/g CNF.

Additionally or alternatively, it is also possible to utilise spherical (carbon) particles such as activated carbon as the surface area increasing additive 112. This can provide the additional advantage of facilitating de-chlorination by the catalyst element 100 in addition to the aforementioned nitrate and/or nitrite reduction. The particle size of such carbon particles may be in the range of from 1 nm to 1 mm, e.g. in the range of from 10 nm to 10 μm.

The material 104 comprising a noble metal may be a metallic or bi-metallic catalyst. In an embodiment, the noble metal may be selected from the group consisting of palladium (Pd), Platinum (Pt), Rhodium (Rh), Ruthenium (Ru), Iridium (Ir) and combinations thereof.

The material 104 comprising a noble metal may further comprise at least one additional non-noble metal selected from the group consisting of copper (Cu), tin (Sn), Cobalt (Co), Nickel (Ni), and combinations thereof.

The inclusion of such a non-noble metal in the material 104 comprising a noble metal may increase the catalytic activity of the catalyst element 100, in particular towards nitrates.

As mentioned above, the coating material 108 may be any material through which flow of H₂ gas is possible and flow of water is not possible. The material 108 for instance may be or comprise a polymer such as a polysiloxane polymer. PDMS (polydimethylsiloxane) is a particularly suitable polysiloxane.

The coating material 108 may be present in the form of a layer. The layer may have a thickness of from 0.1 μm to 1 mm, e.g. from 1 to 200 μm. Such a thickness may be sufficient to prevent unwanted flow of water whilst not requiring excessive use of materials.

As illustrated in FIG. 1 and FIG. 2 the first or the second surface 106,110 may delimit a conduit 114 through the catalyst element 100. In the catalyst element 100 of FIG. 1 and FIG. 2 the second surface 110 delimits a conduit 114 through the catalyst element 100, in use water flows through the conduit 114 of the catalyst element 100 and hydrogen is supplied to the first surface 106 on the outside of the catalyst element 100. However, as will be apparent, alternatively the first surface 106 may delimit a conduit 114 through the catalyst element 100 and the second surface 110 may be on the outside of the catalyst element 100.

The catalyst element 100 having a conduit 114 therethrough may form a hollow structure which may be any shape, such as a cylinder by way of non-limiting example as illustrated in FIG. 1 and FIG. 2.

The inner diameter of such a catalyst element 100 may be in the range of from 100 μm to 100 mm, e.g. from 0.5 mm to 5 mm.

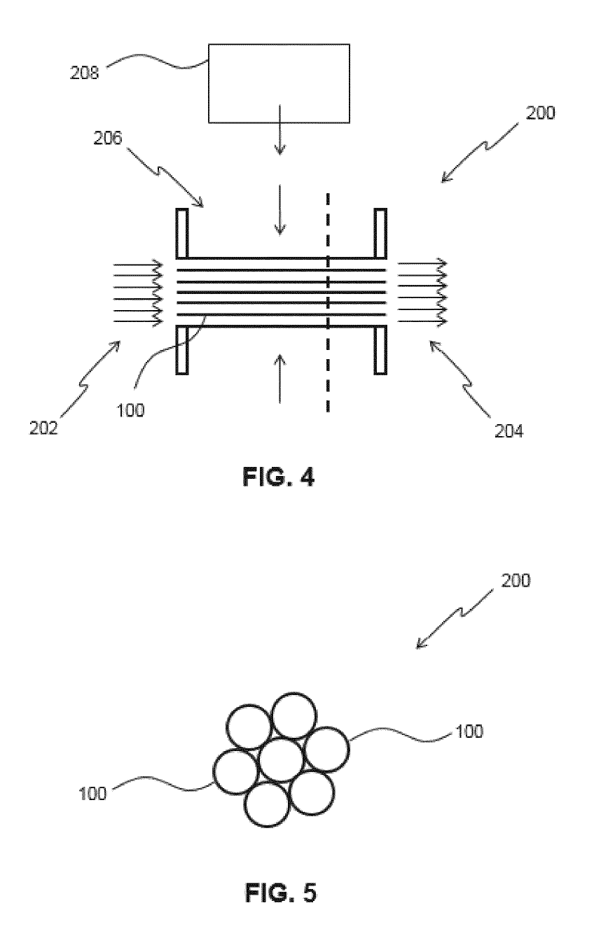

As schematically illustrated in FIGS. 4 and 5, the water purification catalyst element 100 may be included in a water purifier 200. Such a water purifier 200 comprises at least one catalyst element 100 as described above. The water purifier 200 also comprises a water inlet 202 for water to be treated, wherein the water inlet 202 is configured to supply water to the second surface 110 of the at least one catalyst element 100 and a water outlet 204 for treated water, wherein the water outlet 204 is configured to draw water from the second surface 110 of the at least one catalyst element 100. The water inlet 202 and the water outlet 204 define a water flow path over the second surface 110 of the at least one catalyst element 100. The water purifier 200 also comprises a gas inlet 206 for hydrogen gas, wherein the gas inlet 206 is configured to supply hydrogen gas to the first surface 106 of the at least one catalyst element 100.

The inclusion of the catalyst element 100 in a water purifier 200 can ensure effective removal of nitrites or nitrites and nitrates from the water without the generation of significant amounts of by-products such as ammonium ions, as previously explained. The water purifier 200 may be designed such that sufficient reducing agent (i.e. hydrogen) is offered to convert nitrates/nitrites into N₂ gas.

A typical flow rate for the water in the water purifier 200 may be in the range of from 0.01 to 101/min for Point of Use and Point of Entry systems, i.e. for personal or consumer use. However, it should be noted that such water purifiers 200 may also be used in water plants and other situations to advantage, where other, e.g. larger, water flow rates may be applied.

The water purifier 200 may comprise multiple hollow catalyst elements 100 (such as fibers) as illustrated in FIG. 4 and FIG. 5. For example, the water purifier 200 may comprise catalyst elements 100 shaped as straight circular tubes with length L, wherein L is from 0.1 cm to 1000 cm, e.g. from 0.5 to 15 cm. The water purifier 200 may comprise from 10¹ to 10⁶ catalyst elements 100, e.g. from 10² to 10⁴ catalyst elements 100, depending upon the application for which the water purifier 200 is intended.

As schematically illustrated in FIG. 4 the water purifier 200 may further comprise a generator 208 for generating hydrogen gas by electrolysis of water and for supplying the gas inlet 206 with the generated hydrogen gas. Because the hydrogen gas is generated in situ it is not necessary to connect the water purifier 200 to an external hydrogen source. Accordingly, such a water purifier 200 may be particularly convenient in small scale systems, such as consumer operated devices.

Alternatively, the hydrogen source could be any other hydrogen source, such as a container pressurized with H₂ gas or from another source such as an organic source e.g. formic acid or partial oxidation of organics which are present within the water to be, treated or which have been specifically added for the purpose of hydrogen production. Other alternatives will be apparent to the skilled person.

For instance, hydrogen may be generated from formic acid by catalytic decomposition to form hydrogen and carbon dioxide according to the following reaction scheme:

CH₂O₂→H₂+CO₂

Suitable catalysts for this catalytic decomposition reaction are known to the skilled person and include platinum.

A typical flow rate of hydrogen gas in the water purifier 200 is in the range of from 0.1 to 100 mg/min of H₂, e.g. in the range of from 0.5 to 10 mg/min for Point of Use and Point of Entry systems. As before, it should be noted that such water purifiers 200 may also be used in water plants and other situations to advantage, where other, e.g. larger, H₂ flow rates may be applied

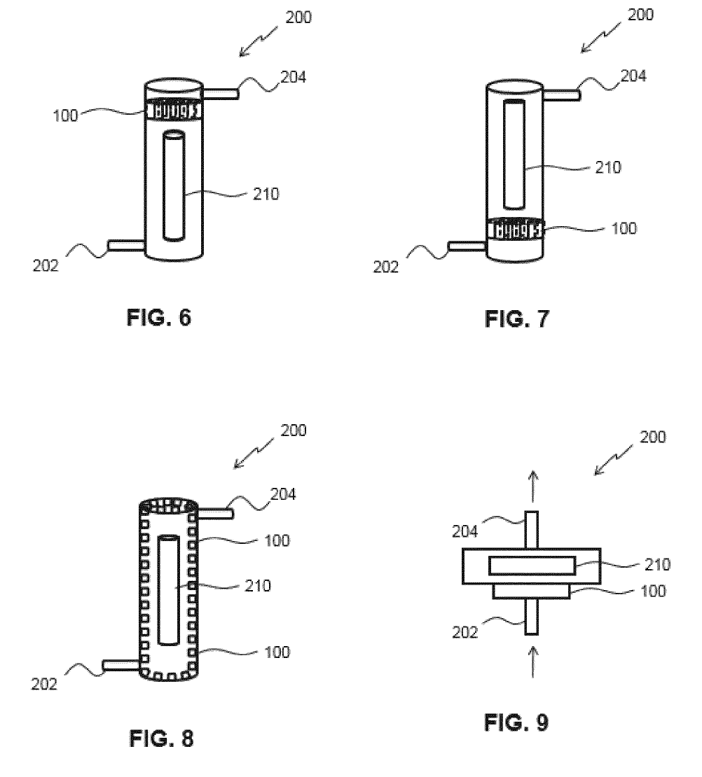

At this point it is noted that in some embodiments, the water purifier 200 may further comprise a light source 210 which emits light in the wavelength range of from 100 nm to 400 nm, wherein the light source 210 is arranged to illuminate the water along at least a portion of the flow path. FIGS. 6 to 9 schematically depict a few example embodiments of water purifiers 200 comprising such light sources 210.

In the example embodiment of FIG. 6, the catalyst element 100 is arranged downstream of the light source 210 in the flow path. This may be an advantageous arrangement where treatment of certain pollutants within the water with the light source 210 results in the formation of nitrites or nitrates and nitrites.

In the example embodiment illustrated in FIG. 7, the catalyst element 100 is arranged upstream of the light source 210 in the flow path. This may be advantageous as the catalyst element 100 can remove the nitrites or nitrates and nitrites from the water before the water is treated with light, which can improve the efficiency of the water purifier 200 as discussed in more detail below.

In the embodiment of FIG. 8, multiple catalyst elements 100 are arranged on an inner wall of the water purifier 200 delimiting the aforementioned flow path. This enables treatment of the water with the light source 210 and the catalyst element 100 simultaneously. As will be apparent, a single catalyst element 100 could instead be mounted, e.g. coated or adhered, on the inner wall of the water purifier 200. Treatment of the water with the catalyst element 100 and the light source 210 simultaneously may be advantageous where treatment of certain pollutants within the water with the light source 210 results in the formation of nitrates and/or nitrites and may also increase the efficiency of the water purifier 200 as discussed below. Moreover, such an arrangement may yield a particular compact water purifier 200, which may be advantageous in consumer applications.

Other examples with multiple light sources 210 or differing orientation of the lamp 210 relative to the water flow as shown schematically in the example embodiment of the water purifier 200 of FIG. 9, will be apparent to the skilled person.

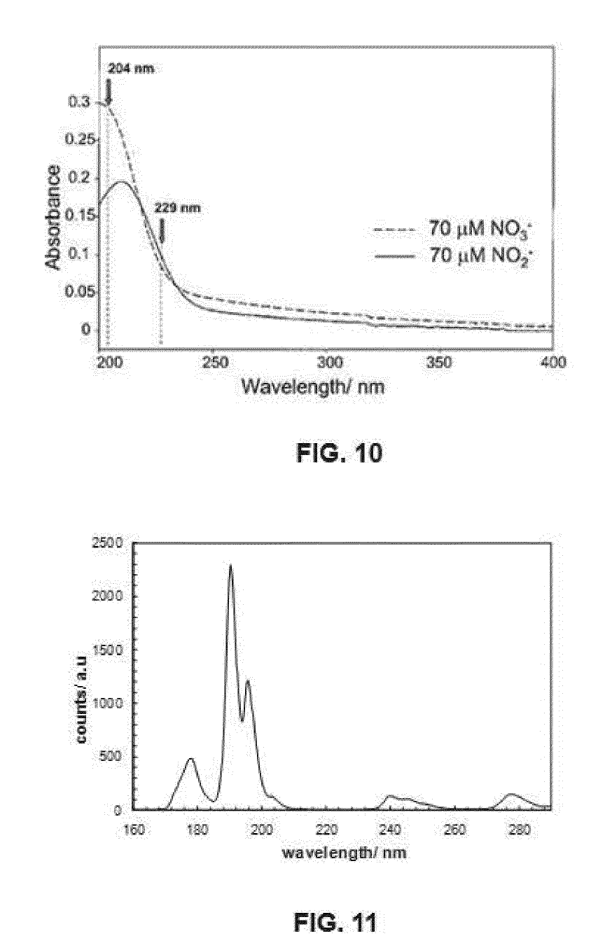

The light source 210 may emit light in the wavelength range of from 100 to 260 nm, e.g. in the range of from 150 to 230 nm. Especially when the wavelength of light emitted is below 230 nm it may be particularly beneficial to include the nitrite and/or nitrate reducing catalyst element 100 in the water purifier 200. This is explained with the aid of FIG. 10 in which the wavelength-dependent absorbance of both nitrite and nitrate are graphically displayed. FIG. 10 demonstrates that significant absorbance will occur both for nitrite and nitrate for wavelengths of 230 nm and lower. Therefore, by removing nitrites or nitrites and nitrates using the catalyst element 100 the amount of light absorption by nitrites and/or nitrates can be reduced. This may be advantageous for two reasons. First, light absorption by nitrates may result in the formation of more harmful nitrites, as discussed above. Second, light absorption by nitrates and by nitrites reduces the amount of light available to carry out the desired decomposition/sterilisation of other contaminants, such that the removal of the nitrates and/or nitrites improves the purification efficiency of the light source 210.

Any light source 210 which provides radiation of the desired wavelengths may be used, for example, the light source 210 may be a lamp or LED. An example of a lamp which may be used is a capacitively coupled Xe excimer lamp (Dielectric Barrier Discharge lamps) with a phosphor coating to provide the desired wavelength conversion. Such lamps are commercially available; the spectrum of a phosphor of such a commercially available Xe excimer lamp has been measured by the inventors and is given in FIG. 11. FIG. 11 depicts an example of the spectrum of the UV light emitted from the light source 210 (after conversion by the phosphor), wherein the x-axis denotes the wavelength (nm) of the UV light, and the y-axis denotes the energy (a.u.) of the UV light. As shown in FIG. 11, the UV light has a main peak at about 193 nm. In an example, at least 10% of the energy of the UV light may be radiated within the wavelength range of from 185 nm to 230 nm. Such a lamp is for instance disclosed in U.S. Pat. No. 7,298,077 B2. The majority of the energy emitted by this lamp is in the VUV region, that is, at a wavelength below 200 nm. The intention of this lamp was especially to break down (organic) chemicals which may be present in water as a contaminant. Such chemicals include pesticides, hormones and industrial pollutants, all of which can be especially harmful if ingested by humans, particularly on a long-term basis. Additionally, such radiation can be used for disinfection, that is, to kill bacteria or other organisms which may be present in the water to be treated.

The light source 210 may be a DBD lamp, or any other suitable light source for generating UV light which is, at least in part, in the wavelength range of from 185 nm to 230 nm, such as an LED (light emitting diode), or any other suitable lamps. In an embodiment, the light source 210 may have an emission spectrum with one or more peaks in the wavelength range of from 185 nm to 230 nm. In another example, at least 40% of the energy of the UV light may be radiated in the wavelength of from 185 nm to 230 nm. In a further example, at least 65% of the energy of the UV light may be radiated in the wavelength of from 185 nm to 230 nm. In some examples, at least 80% of the energy of the UV light may be radiated in the wavelength range of from 185 nm to 230 nm.

In some embodiments, the light source 210 is a DBD lamp having a phosphor coating layer, the DBD lamp may be a capacitively coupled excimer lamp or an electrode-coupled lamp, as is well-known in the art. The light source 210 may be driven by a pulsed electrical signal with a driving frequency between 10 kHz and 200 kHz, in some embodiments between 25 kHz and 75 kHz. Thus, the power for driving the light source 210 can be adjusted by setting different duty cycles for the pulsed electrical signal. In some embodiments, the light source 210 may be driven by other electrical signals such as DC (direct current) signals, and so on. Other alternatives will be apparent to the skilled person.

A phosphor coating layer may be used to convert primary radiation, for example, a radiation in VUV (vacuum UV) range, i.e. less than about 180 nm, of a DBD lamp to the UV radiation in the wavelength range of from about 185 nm to about 230 nm. In an embodiment, the light source 210 has a discharge vessel (not shown) filled with oxygen-free xenon or a mixture of gases that contains xenon, because the xenon filling provides high discharge efficiency with the primary radiation in VUV range. It will be appreciated that the gas filling is not limited to xenon, other gas fillings such as krypton, argon, neon or helium can also be used to generate the primary radiation. In an embodiment, the phosphor coating layer contains a phosphor comprising a host lattice and neodymium (III) as an activator, wherein the phosphor can be anyone of the following or any combination thereof:

(La₁₋ₓYₓ)PO₄:Nd, where 0≦x≦1;
(La₁₋ₓYₓ)PO₄:Nd,Pr, where 0≦x≦1;
SrAl₁₂O₁₉:Nd; LaB₃O₆:Nd; LaMgB₅O₁₀:Nd; SrAl₁₂O₁₉:Nd,Pr; LaBo₃O₆:Nd,Pr; LaMgB₅O₁₀:Nd,Pr and GdPO₄:Nd.

These materials are particularly efficient phosphors under vacuum UV excitation. Further, the energy distribution of the UV light radiated from the light source 210 can be adjusted by changing the composition of the phosphor. Other alternative phosphors will be apparent to the skilled person. The power of the lamp may be in the range of from 0.5 to 300 Watt, e.g. in the range of from 1 to 20 Watt.

The light source 210 may be used as part of an advanced oxidation reactor setup. Such advanced oxidation reactor setups are known to the skilled person and include technologies such as UV-C, UV/O₃ and UV/H₂O₂.

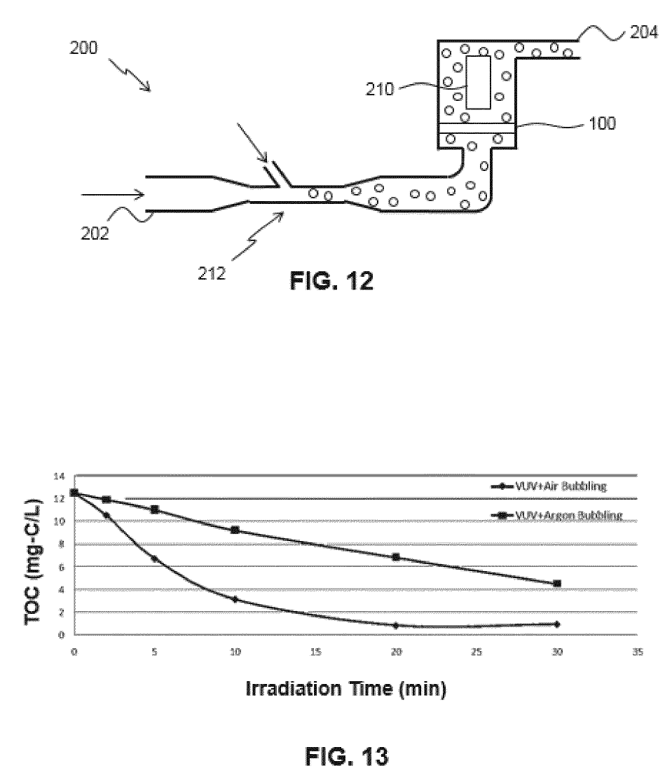

As illustrated schematically in FIG. 12 the water purifier 200 may further comprise an agitator 212 for agitating the water in the flow path. Agitation can help to increase the reaction rate, by ensuring that more nitrates/nitrites come into contact with the catalyst element 100, e.g. by increasing the contact surface area of the nitrates/nitrites-containing water. In turn, this can further reduce the amount of nitrates/nitrites in treated water and/or reduce the size of the catalyst element 100 required to achieve a certain nitrate/nitrite concentration level in the treated water.

In the embodiment illustrated in FIG. 12 the agitator 212 is configured to introduce a gas into the water in the flow path. The agitator 212 introduces a gas such as air, for instance using a Venturi component. In such a component the liquid velocity is increased by reducing the throughput area. In this way a reduction of the pressure compared to the environment is possible. This introduces air, e.g. air bubbles, into the flow of water and this air in turn agitates and mixes the water.

The water purifier 200 may contain other kinds of agitator 212 for agitating the water in the flow path. For example, the introduction of gas such as air using a pump instead of a Venturi device, the introduction of bubbles by an electrolysis stage or the generation of cavitation by creating a pressure below the vapour pressure of water, for example by the use of a narrow section in the flow path. Other alternatives will be apparent to the skilled person.

The introduction of air may have the further advantage of increasing the radical rate formation, as was found in the break-down of potassium hydrogen phthalate (KHP) (C₈H₅KO₄, Mw=204.23,Merck, purity>99.5%). This is demonstrated with reference to FIG. 13 which is a plot of Total Organic Carbon (TOC) against time for argon agitation and air agitation. As can be clearly seen, complete mineralization of KHP takes place faster when air agitation is used than when argon agitation is used. Without wishing to be bound by theory, it is understood that the active species leading to faster decomposition is oxygen; accordingly, instead of air any oxygen containing gas may be used. The conditions used in FIG. 13 were as follows: VUV irradiation with a 0.7 W VUV lamp and a 51/min gas flow of either air or argon. The initial KHP concentration was 26.6 mg/l. The detection limit of TOC was 1 mg/l. oxygen with the detector used.

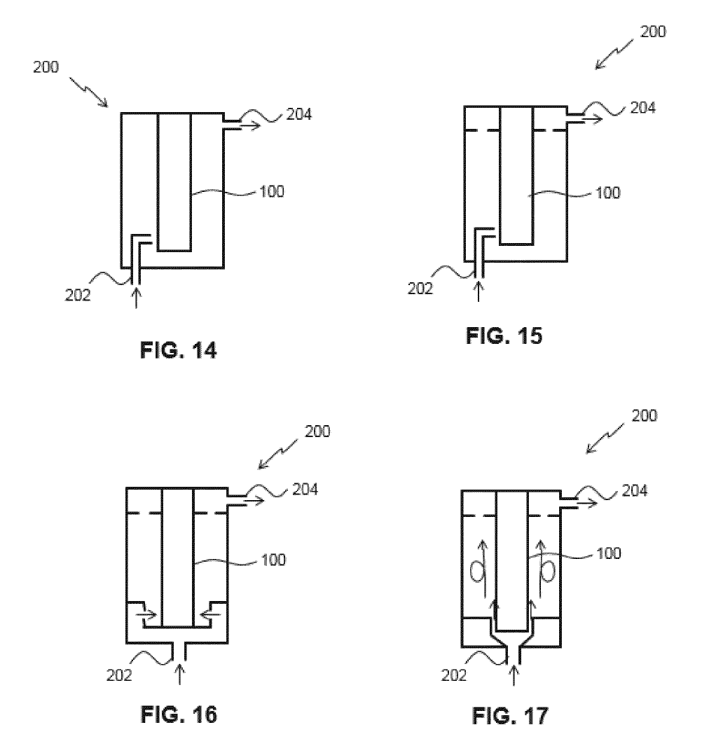

Mixing of the water in the water purifier 200 may also be possible by other agitators 212 such as active mixers or passive mixers which are known per se and will not be explained in further detail for the sake of brevity. Further, agitation may also be possible by the introduction of the water with an initial velocity component significantly perpendicular to the general flow direction of the water purifier 200, as is shown schematically in FIGS. 14 to 16. Additionally or alternatively, agitation may be induced by the arrangement of components within the water purifier 200 to create turbulent flow, as schematically illustrated in FIG. 17.

In another possible embodiment, the gas and water flow are reversed, i.e. the gas flows in the opposite direction to the water flow, in order to create turbulence and the agitation of the water flow.

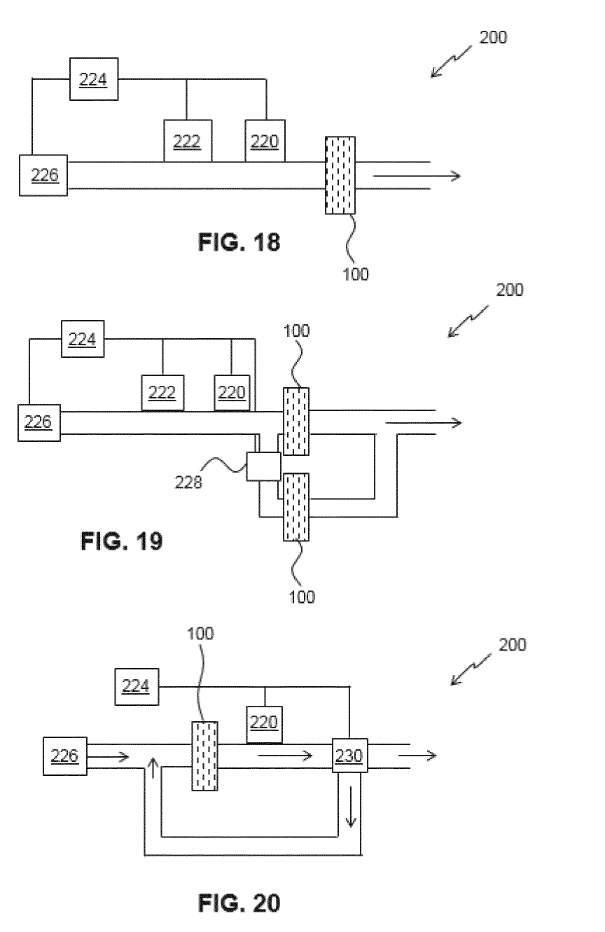

As schematically illustrated in FIGS. 18 to 20, it is also possible to integrate a nitrate and/or nitrite detector 220 (such as a UV-VIS spectrometer) into the water purifier 200 to advantage. With such a detector 220 it is possible, for example, to measure the nitrate/nitrite concentration of the water to be treated before treatment and/or the treated water after treatment.

With particular reference to FIG. 18, the illustrated water purifier 200 comprises a detector 220, a flow meter 222, a controller 224 and a flow adjuster 226. The flow adjuster may be a valve, a variable flow pump or any other means known to the skilled person capable of adjusting the flow of water to be treated through the catalyst element 100. The controller 224 may be any known controller, such as a processor, e.g. a microprocessor.

In this arrangement the controller receives signals from the detector 220 and the flow meter 222. In response to these signals the controller adjusts the flow adjuster 226 and thereby the flow rate of the water to be treated. In this way the flow through the catalyst element 100 can be adjusted such that it matches the nitrate/nitrite removal efficiency of the catalyst element 100. This can be used to ensure that the nitrate/nitrite removal is acceptable for the intended purpose of the water, e.g. satisfactory concentrations for drinking water.

Alternative arrangements can be used to a similar effect. For example, as illustrated with reference to FIG. 19 two catalyst elements 100 may be used and the flow through the catalyst elements 100 may be adjusted with a flow split adjuster 228. The flow split adjuster 228 may be any suitable means known to the skilled person such as a valve or a pump. With the arrangement of FIG. 19 the flow rate through the purifier 200 may be maintained constant and when the amount of nitrate and/or nitrite within the water to be treated is high, as detected by the detector 220, both elements 100 may be used and when the amount of nitrate and/or nitrite is low only one element 100 may be used. Of course, any number of additional elements 100 may be included so as to provide greater capacity for water treatment as required in the particular application for which the water purifier 200 is intended. In this arrangement, it may be possible to omit the flow adjuster 226 from the water purifier 200, as instead of adjusting the flow in response to the treatment nitrate/nitrite concentration of the water to be treated, the treatment capacity is adjusted in response to the nitrate/nitrite concentration.

Other arrangements will be apparent to the skilled person, for example the nitrate/nitrite concentration of the treated water may be measured after treatment with the catalyst element 100 as a verification of the proper operation of the catalyst element 100. Such an arrangement may be used with a water purifier as schematically illustrated in FIG. 18 or FIG. 19, for example.

Another water purifier 200 is schematically illustrated in FIG. 20, in this water purifier 200 instead of an in line arrangement a batch arrangement is used. In this batch purifier 200 the water is guided multiple times through the catalyst element 100 and each time the output concentration is measured with the detector 220. When the concentration of the nitrates/nitrites has reached a desired value the water can then be allowed to exit the system using the flow adjuster 230.

All of the water purifier 200 arrangements illustrated with reference to FIGS. 18 to 20 may be used with a light source 210, as discussed above. The light source 210 may be used upstream, downstream or at the same location as the catalyst element 100. In particular, a light source 210 which is part of an advanced oxidation reactor setup, such as UV-C, UV/O3 and UV/H2O2 may be used. Additionally, any other feature of the embodiments described above may be included, such as an agitator 212.

The nitrate and/or nitrite detector 220 may be any such detector known to the skilled person. For example, the detector 220 may be ,a UV-VIS detector, optionally including a suitable calibration routine. Such a detector could for instance be as described in U.S. Pat. No. 6,956,648 or in the publication On-line nitrate monitoring in sewers using UV/VIS spectroscopy, Hofstaedter F., Ertl T., Langergraber G., Lettl W., Weingartner A., Oral presentation at “Odpadni vody—Wastewater 2003” in Olomouc, Czech Republic, May 13-15, 2003 which is freely available on the internet.

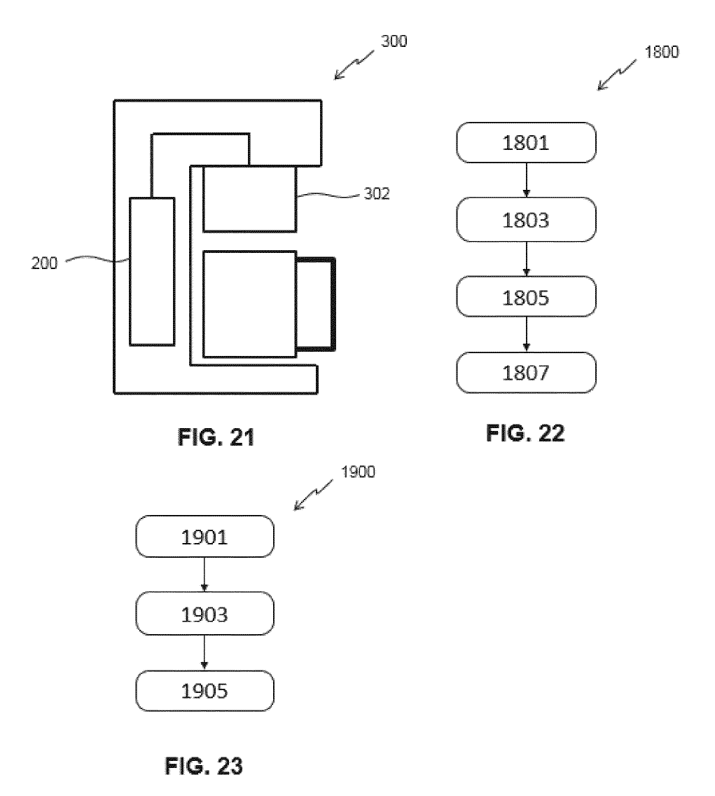

As shown in FIG. 21 the water purifier 200 may be incorporated into a beverage maker 300. The water purifier 200 is arranged to provide purified water to a beverage making stage 302, e.g. a brewing stage, of the beverage maker 300. The beverage maker 300 may be any suitable type of beverage maker 300, for example a coffee machine or a tea maker.

As illustrated with reference to FIG. 22 the catalyst element 100 may be used in a method of purifying water. FIG. 22 depicts a flow chart of an example embodiment of this method. The method starts in step 1801 which may include powering up systems for implementing the method, such as switching on a water supply and/or a hydrogen gas supply. The method subsequently proceeds to step 1803 in which hydrogen gas is supplied to a first surface 106 of a water-permeable porous support 102 having a material 104 comprising a noble metal supported thereon, wherein the first surface 106 is coated with a coating material 108 permeable to the hydrogen gas and impermeable to water. Also in step 1803 water to be treated is supplied to a water-permeable second surface 110 of the porous support 102. This results in the reduction of nitrates/nitrites, if present, in the water to be treated without the significant build-up of by-products such as ammonium ions as explained in more detail above.

The method may include optional further steps 1805 such as treatment with a light source 210, such as a light source 210 described above. The further steps 1805 may include detection of nitrite/nitrate concentrations in the water to be treated or the treated water and adjustment of the flow rate of water in response thereto or adjustment of the number of catalyst elements 200 operative in the treatment of the water, such as described above with particular reference to FIGS. 18 to 20.

After step 1805 the method terminates in step 1807. It should be understood that although step 1805 is shown as subsequent to step 1803, it is equally feasible that step 1805 is performed simultaneously with or prior to step 1803.

The catalyst element 100 described above may be manufactured by a method illustrated with reference to FIG. 23 which depicts a flow chart of a method of manufacturing such a catalyst element 100. The method begins with step 1901 which comprises providing a water-permeable porous support 102 having a material 104 comprising a noble metal supported thereon and having a first surface 106 and a second surface 110. The method subsequently proceeds to step 1903 in which a coating 108 of a coating material is formed on at least the first surface 106, wherein the coating material is permeable to hydrogen gas and impermeable to water. The coating 108 of the coating material may be formed on the first surface 106 using a dip coating method. To prevent the coating 108 of the coating material forming on the second surface the second surface may be temporarily blocked, for example using glue. After step 1903 the method terminates in step 1905. It should be understood that further (sub-)steps may be present. For example, the provision of the water-permeable porous support 102 having a material 104 comprising a noble metal supported thereon may further comprise the sub-step of impregnating or otherwise providing the porous support 102 with the material 104, for instance by suspending the material 104 in a suitable solvent and impregnating the water-permeable porous support 102 with the solvent including the suspension, and/or the sub-step of growing a surface area-increasing additive 112 on the water-permeable porous support 102 and providing the material 104 to the surface area-increasing additive 112 as explained in more detail above.

The present invention will now be explained in further detail by the following examples. It should be understood that these examples are for illustrative purposes only and are not intended to limit the scope of the invention.

### Catalyst Element Manufacturing Example 1

HF alumina material supplied by HyFlux CEPAparation Technologies Europe, InnoCep-N-800 was used and a Ni carbon growth catalyst was incorporated using the following process steps:

A hollow alumina fiber without any previous treatment was immersed in a Ni nitrate solution (0.5 mg/80 ml). The Ni nitrate solution was adjusted to pH=3.5 using a diluted nitric acid (concentration 1%). In order to precipitate the Ni onto the alumina, 20 ml of a concentrated urea solution (1.06 g/20 ml) was added dropwise to begin precipitation of the Ni. The temperature was then adjusted to and kept at 100° C. to bring about decomposition of the urea. After 2 h of deposition time, the sample was rinsed with Type 1 ultrapure water in accordance with ISO 3696 (Milli Q water as provided by the Millipore Corporation) and dried for 2 h at 80° C. under vacuum.

CNFs were then incorporated into the catalyst element by flushing the catalyst element with ethylene gas at temperatures of around 600° C. However, temperatures between 400° C. and 750° C. may be used. The ethylene gas decomposes resulting in the deposition of carbon and the formation of CNF on the hollow alumina fiber.

Subsequently the material comprising a noble metal is incorporated. An impregnation technique was used, the catalyst element was immersed in toluene solvent (other suitable solvents will be apparent to the skilled person and for instance include THF and water) containing a noble metal precursor Pd acetylacetonate (other suitable noble metal precursors known to the skilled person may be used, such as Pd hexachloroplatinate). The catalyst element was left in this solution for several hours (15-25 h, however time of up to 48 h or more may be used). After impregnation of the catalyst element, the catalyst element was calcined in an air flow for about 1 hour and subsequently reduced for about 2 hours in a gas mixture of 50% H₂/50% N₂ (at a temperature between 20° C. and 500° C.).

The first surface was subsequently coated with a PDMS layer having a thickness of between 5 and 150 μm by a dip coating method to yield the noble metal-impregnated catalyst element.

The use of some care in the dip coating method may be advantageous. The viscosity of pristine PDMS is may be too high for coating hollow alumina fibers and a very dilute solution may have a very low viscosity which can result in defective coating. Therefore, a dilute solution of PDMS can be pre cross-linked prior to coating to provide a desired viscosity. In this method, a two component PDMS kit RTV-A (pre polymer) and RTV-B (curing agent) were dissolved in toluene at 85% (w/w) and heated to 60° in a reflux setup to provide pre crosslinking. When the viscosity of the solution reached 100 mPa·s the crosslinking was stopped by cooling the solution by immersing the solvent container in ice. To prevent the inside (second surface) of the hollow alumina fibers from being coating with the PMDS, prior to dip coating one end of the hollow alumina fibers was sealed with a suitable glue. The sealed hollow alumina fiber was dip-coated in a KSV instrument dip coater at 150 mm/minute speed.

Suitable, alternatives will be apparent to the skilled person, for example, instead of toluene another suitable solvent could be used, for example hexane. It is believed that the optimum concentration of PDMS in the solvent is 85% (w/w) in toluene, but as will be apparent to the skilled person different concentrations could also be used. As will also be apparent to the skilled person, where a lower solvent concentration is used, the pre cross-linking time should be shortened and where a higher solvent concentration is used, the pre cross-linking time should be lengthened.

It is reiterated that the above manufacturing example is a non-limiting example only and that other alternative methods of forming such catalyst elements will be apparent to the skilled person, for example a wet impregnation followed by heating under vacuum conditions can be utilized. In such a method the solvent is evaporated 20 minutes to 24 hours depending on the conditions applied. Alternatively, an incipient wet impregnation technique can be applied. In such a method the catalyst solution is added to the catalyst element in such a way that the volume of the solution is equal to the volume of the pores of the porous support and the catalyst element is dried.

### Catalyst Element Manufacturing Example 2

The catalyst element manufacturing example 2 is that same as the catalyst element manufacturing example 1, except as follows. In this example the noble metal precursor Pd acetylacetone (6 mg per ml) was used. The deposition time was 17 h in toluene. After the impregnation the catalyst element was dried under vacuum at 80 C for 2 h. The first surface was subsequently coated with a PDMS layer having a thickness of between 5 and 150 μm by a dip coating method as used in example 1 to yield the noble metal-impregnated catalyst element.

### Catalyst Element Manufacturing Example 3

A catalyst element as obtained by catalyst element manufacturing example 1 was modified by adding Cu to the material comprising the noble metal to form a bimetallic catalyst. The copper was incorporated using a reduction step, however other alternative methods of incorporating copper or other non-noble metals will be apparent to the skilled person. The catalyst element with a Pd noble metal material was immersed in a water solution containing a copper nitrate salt. H₂ was bubbled through the water solution for 24 h (although other reducing agents known to the skilled person could be used, such as formic acid). The copper was reduced at the surface of the Pd creating a good contact between both metals (Pd and Cu). Subsequently the catalyst element was dried for 2 h at 80° C., calcined and reduced and the first surface was subsequently coated with a PDMS layer having a thickness of between 5 and 150 μm by a dip coating method as used in example 1 to obtain the modified catalyst element.

Other suitable manufacturing routes towards such bimetallic catalyst elements will be apparent to the skilled person. For example, Pd and Cu may be precipitated simultaneously using any of the aforementioned techniques. The aforementioned processes ensure a good adherence of Ni, Pd and Cu to the porous support and hence a stable catalyst element.

### Catalyst Element Manufacturing Example 4

A hollow cylindrical catalyst element manufactured in accordance with above manufacturing example 3 was provided with a length of 6.5 cm, inner and outer diameter 1 mm and 2 mm, respectively. Ni particles as a carbon growth catalyst with a diameter of 5-15 nm were homogeneously dispersed on a porous support using a method similar to that described in catalyst element manufacturing example 3.

7 weight % CNF were grown on the carbon growth catalyst using the previously mentioned standard techniques. The CNF diameter was between 5 and 15 nm. The surface area was found to be 220 m²/g CNF or 18 m²/g of the catalyst element. The loading of Pd was between 0.01 and 0.015 g/g CNF. The palladium was found to be in particulate form and the particle diameter was below 2 nm. The first surface was subsequently coated with a PDMS layer having a thickness of between 5 and 150 μm by a dip coating method as used in example 1.

### Water Purification Example

The catalyst element as manufactured in catalyst element manufacturing example 4 was provided with a water flow rate of between 0.05 and 0.2 ml/min and a gas flow rate (H₂/Ar mixture) of up to 200 ml/min. The catalyst element showed to have a 4% nitrite selectivity towards NH₄⁺with a 10% conversion rate and a 30% nitrate selectivity towards NH₄⁺with a 5-10% conversion rate.

In further experiments, a 50% conversion rate and 2-3% ammonia selectivity was achieved. Further, by decreasing the flowrate (higher residence time) it is believed that the conversion rate could reach values close to 100%.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

The term “substantially” herein, such as in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, systems or apparatus, herein are amongst others described during operation. As will be clear to the person skilled in the art, the invention is not limited to methods of operation or devices in operation.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A water purification catalyst element comprising:
a porous support having a first surface and a second surface; and
a material comprising a noble metal supported on the porous support;
wherein at least the first surface is coated with a coating material permeable to hydrogen gas and impermeable to water; and
at least the second surface is water-permeable; and
wherein the first or the second surface delimits a conduit through the catalyst element.

2. A water purification catalyst element according to claim 1, wherein the porous support is or comprises at least one selected from the group consisting of a hydrophilic material, an inorganic material such as α-alumina or γ-alumina and combinations thereof.

3. A water purification catalyst element according to claim 1, wherein the porous support further comprises a surface area increasing additive selected from the group consisting of:
carbon nanofibers (CNF);
carbon nanotubes (CNT);
spherical carbon particles, such as activated carbon; and
combinations thereof,
wherein the material comprising a noble metal is supported on the porous support by the surface area increasing additive.

4. A water purification catalyst element according to claim 1, wherein the noble metal is selected from the group consisting of palladium (Pd), Platinum (Pt), Rhodium (Rh), Ruthenium (Ru), Iridium (Ir) and combinations thereof.

5. A water purification catalyst element according to claim 1, wherein the material comprising a noble metal further comprises at least one additional non-noble metal selected from the group consisting of copper (Cu), tin (Sn), Cobalt (Co), Nickel (Ni), and combinations thereof.

6. A water purification catalyst element according to claim 1, wherein the coating material is or comprises a polymer, such as a polysiloxane polymer.

7. A water purification catalyst element according to claim 1, wherein the second surface delimits a conduit, whereby in use water flows through the conduit.

8. A water purifier comprising:
at least one catalyst element according to claim 1;
a water inlet for water to be treated, wherein the water inlet is configured to supply water to the second surface of the at least one catalyst element;
a water outlet for treated water, wherein the water outlet is configured to draw water from the second surface of the at least one catalyst element; and
a gas inlet for hydrogen gas, wherein the gas inlet is configured to supply hydrogen gas to the first surface of the at least one catalyst element;
wherein the water inlet and the water outlet define a water flow path over the second surface of the at least one catalyst element.

9. A water purifier according to claim 8, further comprising a light source which emits light in the wavelength range of from 100 nm to 400 nm,
wherein the light source is arranged to illuminate the water along at least a portion of the flow path.

10. A water purifier according to claim 8, wherein the catalyst element is arranged upstream of the light source in the flow path.

11. A water purifiers according to claim 8, further comprising an agitator for agitating the water in the flow path;
optionally wherein the agitator is configured to introduce a gas into the water in the flow path.

12. A water purifier according to claim 8, further comprising a generator for generating hydrogen gas by electrolysis of water and for supplying the gas inlet with hydrogen gas.

13. A beverage maker comprising a water purifier according to claim 8, wherein the water purifier is arranged to provide purified water to a beverage making stage of the beverage maker.

14. A method of water purification comprising:
supplying hydrogen gas and water to be treated to a water purifier according to claim 8, wherein hydrogen gas is supplied to said first surface of the water-permeable porous support, and wherein the water to be treated is supplied to said water-permeable second surface of the porous support said first surface.

15. A method of making a catalyst element comprising:
providing a water-permeable porous support having a material comprising a noble metal supported thereon and having a first surface and a second surface; and
forming a coating of a coating material on at least the first surface, wherein the coating material is permeable to hydrogen gas and impermeable to water, and leaving at least the second surface water-permeable.
